(19) United States
(12) Patent Application Publication
(10) Pub. No.: US 2022/0300208 A1
(43) Pub. Date: Sep. 22, 2022

(54) MEMORY READ PERFORMANCE TECHNIQUES

(71) Applicant: Micron Technology, Inc., Boise, ID (US)

(72) Inventors: Deping He, Boisde, ID (US); Jonathan S. Parry, Boisde, ID (US); Jingyuan Miao, Boisde, ID (US); Bin Zhao, Shanghai (CN)

(21) Appl. No.: 17/631,201

(22) PCT Filed: Mar. 18, 2021
(86) PCT No.: PCT/CN2021/081466

§ 371 Date: Jan. 28, 2022

(51) Int. Cl. G06F 3/06

(52) U.S. Cl. CPC G06F 3/0659; G06F 3/0656; G06F 3/064; G06F 3/0631; G06F 3/0604; G06F 3/0673

(57) ABSTRACT

Methods, systems, and devices for memory read performance techniques are described. A memory system may receive a sequence of read commands. Based on detecting a set of consecutive read commands, the memory system may pre-read data from a second logical block address (LBA) in a non-volatile memory device to a volatile memory device based on receiving a first read command that includes a first LBA, where the second LBA is consecutive with the first LBA. The memory system may subsequently receive a second read command that includes the second LBA, and read out the second data without performing an additional access operation of the non-volatile storage device. In some examples, using such a pre-read, the memory system may capable of returning data in a different order than the order in which the commands were received.

### CROSS REFERENCE

The present Application for Patent is a 371 national phase filing of International Patent Application No. PCT/CN2021/081466 by H E et al., entitled “MEMORY READ PERFORMANCE TECHNIQUES,” filed Mar. 18, 2021, assigned to the assignee hereof, and expressly incorporated by reference herein.

### FIELD OF TECHNOLOGY

The following relates generally to one or more systems for memory and more specifically to memory read performance techniques.

### BACKGROUND

Memory devices are widely used to store information in various electronic devices such as computers, user devices, wireless communication devices, cameras, digital displays, and the like. Information is stored by programing memory cells within a memory device to various states. For example, binary memory cells may be programmed to one of two supported states, often corresponding to a logic 1 or a logic 0. In some examples, a single memory cell may support more than two possible states, any one of which may be stored by the memory cell. To access information stored by a memory device, a component may read, or sense, the state of one or more memory cells within the memory device. To store information, a component may write, or program, one or more memory cells within the memory device to corresponding states.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), 3-dimensional cross-point memory (3D cross point), not-or (NOR) and not-and (NAND) memory devices, and others. Memory devices may be volatile or non-volatile. Volatile memory cells (e.g., DRAM cells) may lose their programmed states over time unless they are periodically refreshed by an external power source. Non-volatile memory cells (e.g., NAND memory cells) may maintain their programmed states for extended periods of time even in the absence of an external power source.

### BRIEF DESCRIPTION OF THE DRAWINGS

FIG. 1 illustrates an example of a system that supports memory read performance techniques in accordance with examples as disclosed herein.

FIG. 2 illustrates an example of a process flow that supports memory read performance techniques in accordance with examples as disclosed herein.

FIG. 3 shows a block diagram of a memory system that supports memory read performance techniques in accordance with examples as disclosed herein.

FIGS. 4 and 5 show flowcharts illustrating a method or methods that support memory read performance techniques in accordance with examples as disclosed herein.

### DETAILED DESCRIPTION

Memory devices of a memory system may store data at a corresponding physical address, where a physical address may identify a physical location of a corresponding memory cell (e.g., or a page of memory cells) within a memory device. The physical location of data within the memory device may change over time due to the memory device accommodating the writing of additional data, maintenance operations performed by the memory device (e.g., garbage collection operations), or for other reasons. A host system coupled with the memory system may reference data (e.g., if issuing read, write, or other commands associated with the data) using logical addresses (e.g., logical block addresses (LBAs), virtual addresses, system addresses, or other logical addresses), and the memory device (e.g., or the memory system) may generate and maintain a mapping between the logical addresses used in the communications with the host system and the physical addresses of the memory cells at which the data is stored, which may support the memory device changing the physical addresses over time.

A memory system may receive a sequence of read commands (e.g., a sequence of consecutive read commands with corresponding LBAs that include sequential blocks of memory) from a host system, for example as part of a benchmarking procedure. In some cases, the memory system may perform each read command individually, which may result in increased power consumption. For example, the memory system may energize a memory array as part of performing each read command, which may include opening ang closing the memory array with each read command. Additionally, in some cases, performing the read commands in the order they are received may result in increased power consumption, for example based on physical locations of memory blocks associated with the read commands.

Techniques, systems, and devices are described herein for increasing performance and reducing latency associated with performing read commands. A memory system may receive a sequence of read commands, for example from a host system. In some examples, the memory system may detect that one or more consecutive read commands have corresponding LBAs that include sequential blocks of memory. Based on detecting the consecutive read commands, the memory system may perform a blind sequential read (e.g., a pre-read or a pre-fetch of data associated with predicted LBAs). That is, the memory system may receive a first read command that includes a first LBA. Based on the first read command, the memory system may load first data associated with the first LBA into a page buffer (e.g., a page buffer of a not-and (NAND) memory device) and also load second data associated with a second LBA into the page buffer. The second LBA may be consecutive with the first LBA. Loading the second data may be associated with a pre-read operation at the page buffer. That is, the memory system may load the first data and the second data in a single access operation of a non-volatile memory device (e.g., a NAND device). The memory system may make a prediction that the data of the second LBA may be requested in the future and may pre-read or pre-fetch the data based on that prediction. Based on the first read command, the memory system may transfer the first data from the page buffer to a read buffer (e.g., a static random access memory (SRAM) buffer of the memory system) in preparation for reading out the first data to the host system.

The memory system may subsequently receive a second read command that includes the second LBA. After receiving the second read command, the memory system may transfer the second data from the page buffer to the read buffer without performing a second access operation of the non-volatile memory device (e.g., the NAND device), which may reduce power consumption at the memory system. In some examples, the memory system may determine, based on the first read command being consecutive with a quantity of read commands in a command buffer, that the second read command may subsequently be received, and pre-read the second data into the page buffer.

In some examples, the memory system may perform a pre-read operation that does not correspond to a next read command. For example, the memory system may load into the page buffer third data associated with a third LBA that is consecutive with the second LBA. After loading the third data, the memory system may receive a third read command that includes a fourth LBA different from the third LBA. Accordingly, the memory system may perform an access operation to load fourth data associated with the fourth LBA. The memory system may overwrite the third data loaded in the page buffer based on receiving the third read command that did not include the third LBA.

In some examples, the memory system may receive a first read command and a second read command, where first data is associated with a first LBA of the first read command and second data is associated with a second LBA of the second read command. As part of transferring the first data and the second data to the host system, the memory system may transfer a first portion of the second data before transferring a second portion of the first data. For example, the first and second data may be larger than the space available in the page buffer, the read buffer, or the cache (e.g., the first and second data may each have a size of 128 kilobytes (kB), while the read buffer may store 23 kB). In some cases, the first and second data may be transferred to the host system in portions. It may be advantageous to return a portion of the data associated with the second set of data before returning a portion of the data associated with the first set of data, despite the first read command being received before the second read command. For example, the time to perform the read commands may be reduced based on returning portions of data out of order compared to the order of the read commands.

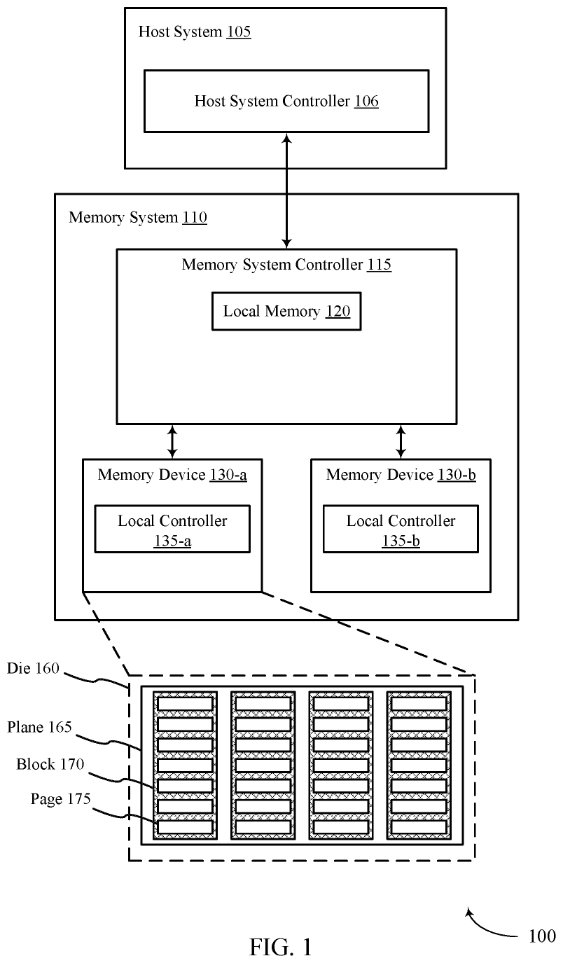

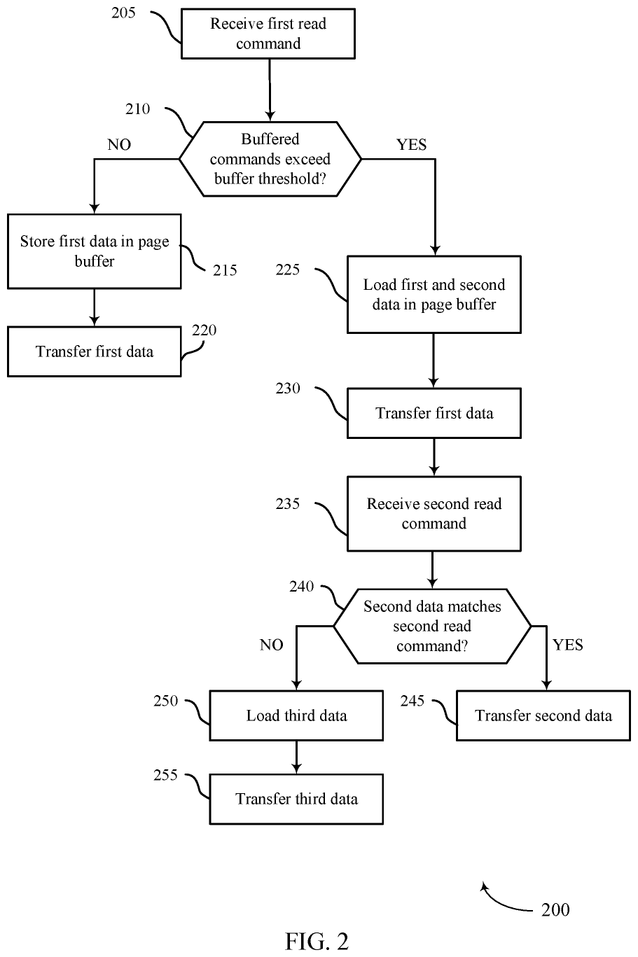

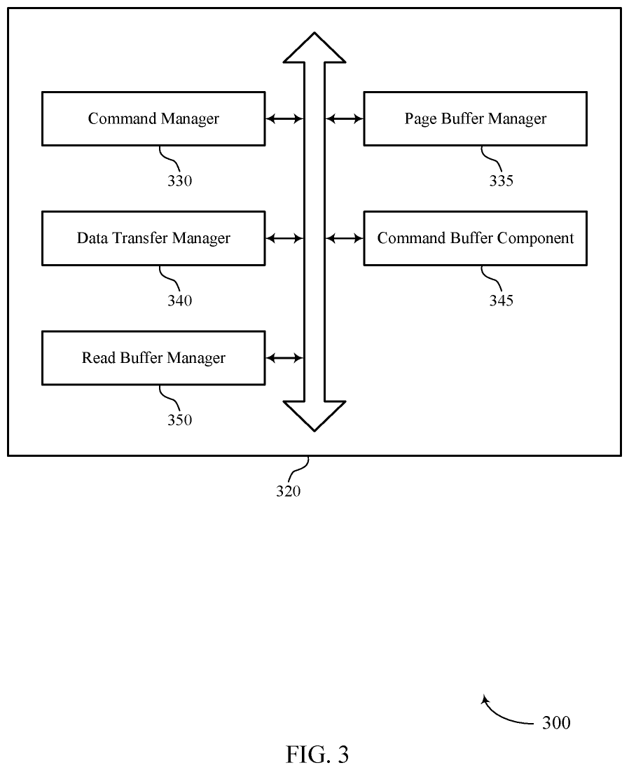

Features of the disclosure are initially described in the context of systems with reference to FIG. 1. Features of the disclosure are described in the context of a process flow with reference to FIG. 2. These and other features of the disclosure are further illustrated by and described in the context of an apparatus diagram and flowcharts that relate to memory write performance techniques with reference to FIGS. 3-5.

FIG. 1 illustrates an example of a system 100 that supports memory read performance techniques in accordance with examples as disclosed herein. The system 100 includes a host system 105 coupled with a memory system 110.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other possibilities.

The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices, and in some cases may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may in some cases be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., LBAs) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally or alternatively include SRAM or other memory that may be used by the memory system controller 115 for internal storage or calculations, for example, related to the functions ascribed herein to the memory system controller 115. Additionally or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally or alternatively rely upon an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may in some cases instead be performed by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (RAM) (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on a same die or within a same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a memory die 160. For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170, and in some cases, concurrent operations may take place within different planes 165. For example, concurrent operations may be performed on memory cells within different blocks 170 so long as the different blocks 170 are in different planes 165. In some cases, performing concurrent operations in different planes 165 may be subject to one or more restrictions, such as identical operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in a same page 175 may share (e.g., be coupled with) a common word line, and memory cells in a same string may share (e.g., be coupled with) a common digit line (which may alternatively be referred to as a bit line).

For some NAND architectures, memory cells may be read and programmed (e.g., written) at a first level of granularity (e.g., at the page level of granularity) but may be erased at a second level of granularity (e.g., at the block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may in some cases not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

According to the techniques described herein, the memory system 110 may receive a sequence of read commands, for example from the host system 105. In some examples, based on detecting a set of consecutive read commands, the memory system 110 may pre-read data from a second LBA based on receiving a first read command that includes a first LBA, where the second LBA is consecutive with the first LBA. The memory system 110 may subsequently receive a second read command that includes the second LBA, and read out the second data without performing an additional access operation, which may reduce power consumption at the memory system 110.

In some examples, the memory system 110 may receive a first read command and a second read command, where first data is associated with a first LBA of the first read command and second data is associated with a second LBA of the second read command. As part of transferring the first data and the second data to the host system 105, the memory system 110 may return a portion of the data associated with the second set of data before returning a portion of the data associated with the first set of data, despite the first read command being received before the second read command. The time to perform the read commands may be reduced based on returning portions of data out of order compared to the order of the read commands.

The system 100 may include any quantity of non-transitory computer readable media that support memory write performance techniques. For example, the host system 105, the memory system controller 115, or a memory device 130 may include or otherwise may access one or more non-transitory computer readable media storing instructions (e.g., firmware) for performing the functions ascribed herein to the host system 105, memory system controller 115, or memory device 130. For example, such instructions, if executed by the host system 105 (e.g., by the host system controller 106), by the memory system controller 115, or by a memory device 130 (e.g., by a local controller 135), may cause the host system 105, memory system controller 115, or memory device 130 to perform one or more associated functions as described herein.

FIG. 2 illustrates an example of a process flow 200 that supports memory read performance techniques in accordance with examples as disclosed herein. The process flow 200 may be performed by components of a memory system, such as a memory system 110 described with reference to FIG. 1. For example, the process flow 200 may be performed by a controller of a memory system or a memory device (or both) such as a memory system controller 115 or a local controller 135 as described with reference to FIG. 1. The process flow 200 may depict a process for performing commands based on a relationship between logical addresses of the commands. The process flow 200 may be implemented to reduce latency and power consumption and increase system performance, among other benefits. Aspects of the process flow 200 may be implemented by a controller, among other components. Additionally or alternatively, aspects of the process flow 200 may be implemented as instructions stored in memory (e.g., firmware stored in a memory coupled with the memory system controller 115 or the local controller 135). For example, the instructions, if executed by a controller (e.g., a memory system controller 115, a local controller 135), may cause the controller to perform the operations of the process flow 200.

In the following description of the process flow 200, the operations may be performed in different orders or at different times. Some operations may also be omitted from the process flow 200, and other operations may be added to the process flow 200.

In some examples, the memory system may include a page buffer, a read buffer, and a command buffer. In some cases, the page buffer may be coupled with an array of memory cells of a non-volatile memory device (e.g., a NAND memory device), and may store portions of data (e.g., pages of data) retrieved from the non-volatile memory device. The read buffer may be included in a volatile memory device (e.g., an SRAM device) and store data associated with a read command to be transferred to the host system. Data stored in the page buffer may be transferred to the read buffer before being transmitted to the host system. Commands that have been received but not executed may be stored in the command buffer. In some cases, the quantity of commands stored in the command buffer may be referred to as a queue depth.

At 205, a first read command may be received. For example, the memory system may receive a read command that includes a first LBA of the non-volatile memory device. In some cases, the read command may be stored in the command buffer. Additionally or alternatively, the memory system may, in response to receiving the first read command, allocate a first portion of the read buffer for first data corresponding to the first read command.

At 210, the memory system may determine whether a quantity of read commands stored in the command buffer satisfies a buffer threshold. For example, the memory system may determine whether the queue depth of the command buffer exceeds the buffer threshold. In some cases, the memory system may also determine whether the read commands stored in the read buffer include consecutive read commands. That is, the memory system may determine whether the each of the sequence of read commands correspond to LBAs that include continuous blocks of memory. Consecutive read commands may refer to read commands received from the host system that include consecutively indexed LBAs. For example, a set of consecutive read commands may include a first read command with LBA 1059, a second read command with LBA 1060, a third read command with LBA 1061 and so forth. Non-consecutive read commands may refer to read commands received from the host system that include LBAs that are not related by a consecutive pattern. For example, a set of non-consecutive read commands may include a first read command with LBA 1059, a second read command with LBA 0457, and a third read command with LBA 2051.

In some cases, the memory system may determine that the quantity of read commands stored in the command buffer does not satisfy the buffer threshold. For example, determining whether the quantity of read commands satisfies the buffer threshold may include comparing the quantity of read commands to a queue depth threshold (e.g., determining a quantity of commands that have been received but not executed). If, at 210, the memory system determines that the quantity of read commands stored in the command buffer does not satisfy the buffer threshold, the controller may perform 215 and 220.

At 215, the memory system may load the first data associated with the first read command in the page buffer. For example, the memory system may read the first data corresponding to the first LBA included in the first read command and load the first data in the page buffer. At 220, the first data may be transferred from the page buffer to the read buffer (e.g., via the cache), to be read out to the host system.

In some cases, the memory system may determine that the quantity of read commands stored in the command buffer satisfies the buffer threshold. For example, determining whether the quantity of read commands satisfies the buffer threshold may include comparing the quantity of read commands to a queue depth threshold (e.g., determining a quantity of commands that have been received but not executed). If, at 210, the memory system determines that the quantity of read commands stored in the command buffer satisfies the buffer threshold, the controller may perform 225 through 240.

At 225, the memory system may store, in the page buffer, the first data associated with the first read command and second data. In some examples, the second data may correspond to a second LBA that is consecutive with the first LBA. That is, the memory system may pre-read the second data into the page buffer. In some examples, the memory system may, in response to receiving the first read command, allocate a second portion of the read buffer for the second data corresponding to the second read command. A pre-read operation may include retrieving data from the non-volatile memory device and storing it in a page buffer before receiving a read command from the host system that explicitly requests that data. A pre-read operation may occur when a memory system makes a prediction that certain data may be requested in the near feature and may retrieve that data pre-emptively. In some examples, a pre-read may also be referred to as a pre-fetch.

At 230, the memory system may transfer (e.g., via the cache) the first data from the page buffer to the read buffer (e.g., the allocated first portion of the read buffer), to be read out to the host system.

At 235, the memory system may receive a second read command, for example from the host system.

At 240, the memory system may determine whether an LBA in the second read command matches the second LBA associated with the second data loaded in the page buffer. In some examples, the second read command may include the second LBA consecutive with the first LBA. If, at 240, the memory system determines that LBA in the second read command matches the second LBA associated with the second data loaded in the page buffer, the controller may perform 245.

At 245, the memory system may transfer (e.g., via the cache) the second data from the page buffer to the read buffer (e.g., the allocated second portion of the read buffer), to be read out to the host system. The memory system may transfer the second data without performing an additional access operation at the non-volatile memory device, which may reduce power consumption at the memory system.

In some examples, the second read command may include a third LBA that does not match the second LBA, where the third LBA may be associated with third data. If, at 240, the memory system determines that LBA in the second read command does not match the second LBA associated with the second data loaded in the page buffer, the controller may perform 250 and 255.

At 250, the memory system may read third data corresponding to the third LBA included in the second read command and load the third data in the page buffer. At 255, the third data may be transferred from the page buffer to the read buffer (e.g., via the cache), to be read out to the host system. In some examples, the memory system may overwrite the second data loaded in the page buffer based on receiving the second read command that did not include the second LBA.

In some examples, the memory system may receive a first read command and a second read command, where first data is associated with a first LBA of the first read command and second data is associated with a second LBA of the second read command. As part of transferring the first data and the second data to the host system, the memory system may transfer a first portion of the second data before transferring a second portion of the first data. For example, the first and second data may be larger than the space available in the page buffer, the read buffer, or the cache (e.g., the first and second data may each have a size of 128 kB, while the read buffer may store 23 kB). In some cases, the first and second data may be transferred to the host system in portions. It may be advantageous to return a portion of the data associated with the second set of data before returning a portion of the data associated with the first set of data, despite the first read command being received before the second read command. For example, the time to perform the read commands may be reduced based on returning portions of data out of order compared to the order of the read commands.

In some cases, a first set of pages may be associated with the first logical block address and a second set of pages may be associated with the second logical block address. In such cases, the first portion of the second data may include a first page of the second set of pages, and the second portion of the first data may include a second page of the first set of pages.

FIG. 3 shows a block diagram 300 of a memory system 320 that supports memory read performance techniques in accordance with examples as disclosed herein. The memory system 320 may be an example of aspects of a memory system as described with reference to FIGS. 1 through 2. The memory system 320, or various components thereof, may be an example of means for performing various aspects of memory read performance techniques as described herein. For example, the memory system 320 may include a command manager 330, a page buffer manager 335, a data transfer manager 340, a command buffer component 345, a read buffer manager 350, or any combination thereof. Each of these components may communicate, directly or indirectly, with one another (e.g., via one or more buses).

The command manager 330 may be configured as or otherwise support a means for receiving a first read command that includes a first logical block address of the memory system. The page buffer manager 335 may be configured as or otherwise support a means for loading, in a page buffer based at least in part on receiving the first read command, first data associated with the first logical block address and second data associated with a second logical block address consecutive with the first logical block address. The data transfer manager 340 may be configured as or otherwise support a means for transferring the first data from the page buffer to a read buffer based at least in part on receiving the first read command and loading the first data in the page buffer. In some examples, the command manager 330 may be configured as or otherwise support a means for receiving, after loading the first data and the second data in the page buffer, a second read command that includes the second logical block address. In some examples, the data transfer manager 340 may be configured as or otherwise support a means for transferring the second data from the page buffer to the read buffer based at least in part on receiving the second read command and loading the second data in the page buffer.

In some examples, the command buffer component 345 may be configured as or otherwise support a means for determining whether a quantity of read commands stored in a command buffer before being performed satisfies a buffer threshold, where loading the second data in the page buffer is further based at least in part on determining whether the quantity of read commands satisfies the buffer threshold.

In some examples, the page buffer manager 335 may be configured as or otherwise support a means for loading, in the page buffer, third data from a third logical block address consecutive with the second logical block address based at least in part on receiving the first read command. In some examples, the command manager 330 may be configured as or otherwise support a means for receiving, after loading the third data in the page buffer, a third read command that includes a fourth logical block address different than the third logical block address. In some examples, the page buffer manager 335 may be configured as or otherwise support a means for loading, in the page buffer, fourth data associated with the fourth logical block address based at least in part on receiving the third read command. In some examples, the data transfer manager 340 may be configured as or otherwise support a means for transferring the fourth data from the page buffer to the read buffer based at least in part on receiving the third read command and loading the fourth data in the page buffer.

In some examples, the page buffer manager 335 may be configured as or otherwise support a means for overwriting the third data loaded in the page buffer based at least in part on receiving the third read command.

In some examples, the read buffer manager 350 may be configured as or otherwise support a means for allocating, in response to receiving the first read command, a first portion of the read buffer for the first data. In some examples, the read buffer manager 350 may be configured as or otherwise support a means for allocating, in response to receiving the second read command, a second portion of the read buffer for the second data.

In some examples, a first physical address associated with the first logical block address and a second physical address associated with the second logical block address are consecutive in the memory system.

In some examples, the page buffer is coupled with an array of memory cells of a non-volatile memory device of the memory system. In some examples, the read buffer is included in a volatile memory device of the memory system.

In some examples, the first data is transferred from the page buffer to the read buffer via a cache at the memory system.

In some examples, the command manager 330 may be configured as or otherwise support a means for receiving, from a host system, a first read command that includes a first logical block address of the memory system. In some examples, the command manager 330 may be configured as or otherwise support a means for receiving, from the host system, a second read command that includes a second logical block address of the memory system based at least in part on receiving the first read command. In some examples, the data transfer manager 340 may be configured as or otherwise support a means for transferring, to the host system and after receiving the first read command and the second read command, first data associated with the first logical block address and second data associated with the second logical block address, where a first portion of the second data is transferred before a second portion of the first data is transferred.

In some examples, the read buffer manager 350 may be configured as or otherwise support a means for allocating, in response to receiving the first read command, a first portion of a read buffer for the first data. In some examples, the read buffer manager 350 may be configured as or otherwise support a means for allocating, in response to receiving the second read command, a second portion of the read buffer for the second data.

In some examples, the first data and the second data are transferred to the host system via the read buffer at the memory system.

In some examples, the second read command is received after the first read command.

In some examples, a first set of pages are associated with the first logical block address and a second set of pages are associated with the second logical block address. In some examples, the first portion of the second data includes a first page of the second set of pages. In some examples, the second portion of the first data includes a second page of the first set of pages.

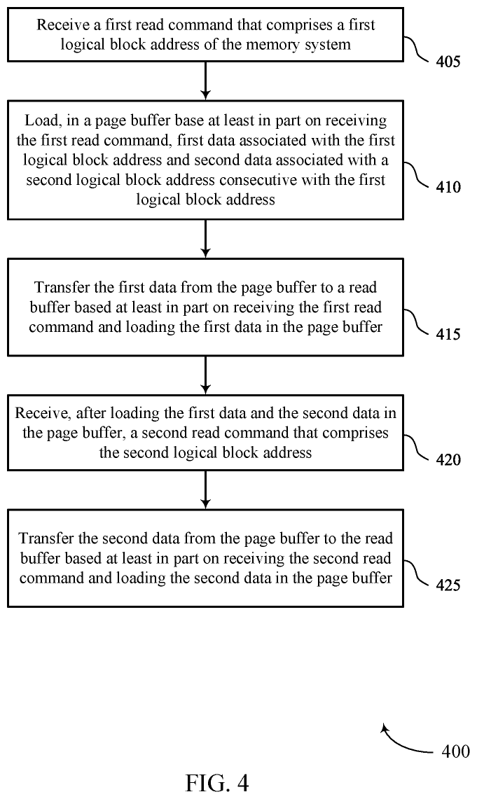

FIG. 4 shows a flowchart illustrating a method 400 that supports memory read performance techniques in accordance with examples as disclosed herein. The operations of method 400 may be implemented by a memory system or its components as described herein. For example, the operations of method 400 may be performed by a memory system as described with reference to FIGS. 1 through 3. In some examples, a memory system may execute a set of instructions to control the functional elements of the device to perform the described functions. Additionally or alternatively, the memory system may perform aspects of the described functions using special-purpose hardware.

At 405, the method may include receiving a first read command that includes a first logical block address of the memory system. The operations of 405 may be performed in accordance with examples as disclosed herein. In some examples, aspects of the operations of 405 may be performed by a command manager 330 as described with reference to FIG. 3.

At 410, the method may include loading, in a page buffer based at least in part on receiving the first read command, first data associated with the first logical block address and second data associated with a second logical block address consecutive with the first logical block address. The operations of 410 may be performed in accordance with examples as disclosed herein. In some examples, aspects of the operations of 410 may be performed by a page buffer manager 335 as described with reference to FIG. 3.

At 415, the method may include transferring the first data from the page buffer to a read buffer based at least in part on receiving the first read command and loading the first data in the page buffer. The operations of 415 may be performed in accordance with examples as disclosed herein. In some examples, aspects of the operations of 415 may be performed by a data transfer manager 340 as described with reference to FIG. 3.

At 420, the method may include receiving, after loading the first data and the second data in the page buffer, a second read command that includes the second logical block address. The operations of 420 may be performed in accordance with examples as disclosed herein. In some examples, aspects of the operations of 420 may be performed by a command manager 330 as described with reference to FIG. 3.

At 425, the method may include transferring the second data from the page buffer to the read buffer based at least in part on receiving the second read command and loading the second data in the page buffer. The operations of 425 may be performed in accordance with examples as disclosed herein. In some examples, aspects of the operations of 425 may be performed by a data transfer manager 340 as described with reference to FIG. 3.

In some examples, an apparatus as described herein may perform a method or methods, such as the method 400. The apparatus may include, features, circuitry, logic, means, or instructions (e.g., a non-transitory computer-readable medium storing instructions executable by a processor) for receiving a first read command that includes a first logical block address of the memory system, loading, in a page buffer based at least in part on receiving the first read command, first data associated with the first logical block address and second data associated with a second logical block address consecutive with the first logical block address, transferring the first data from the page buffer to a read buffer based at least in part on receiving the first read command and loading the first data in the page buffer, receiving, after loading the first data and the second data in the page buffer, a second read command that includes the second logical block address, and transferring the second data from the page buffer to the read buffer based at least in part on receiving the second read command and loading the second data in the page buffer.

Some examples of the method 400 and the apparatus described herein may further include operations, features, circuitry, logic, means, or instructions for determining whether a quantity of read commands stored in a command buffer before being performed satisfies a buffer threshold, where loading the second data in the page buffer may be further based at least in part on determining whether the quantity of read commands satisfies the buffer threshold.

In some examples of the method 400 and the apparatus described herein, loading, in the page buffer, third data from a third logical block address consecutive with the second logical block address based at least in part on receiving the first read command, receiving, after loading the third data in the page buffer, a third read command that includes a fourth logical block address different than the third logical block address, loading, in the page buffer, fourth data associated with the fourth logical block address based at least in part on receiving the third read command, and transferring the fourth data from the page buffer to the read buffer based at least in part on receiving the third read command and loading the fourth data in the page buffer.

Some examples of the method 400 and the apparatus described herein may further include operations, features, circuitry, logic, means, or instructions for overwriting the third data loaded in the page buffer based at least in part on receiving the third read command.

In some examples of the method 400 and the apparatus described herein, allocating, in response to receiving the first read command, a first portion of the read buffer for the first data and allocating, in response to receiving the second read command, a second portion of the read buffer for the second data.

In some examples of the method 400 and the apparatus described herein, a first physical address associated with the first logical block address and a second physical address associated with the second logical block address may be consecutive in the memory system.

In some examples of the method 400 and the apparatus described herein, the page buffer may be coupled with an array of memory cells of a non-volatile memory device of the memory system and the read buffer may be included in a volatile memory device of the memory system.

In some examples of the method 400 and the apparatus described herein, the first data may be transferred from the page buffer to the read buffer via a cache at the memory system.

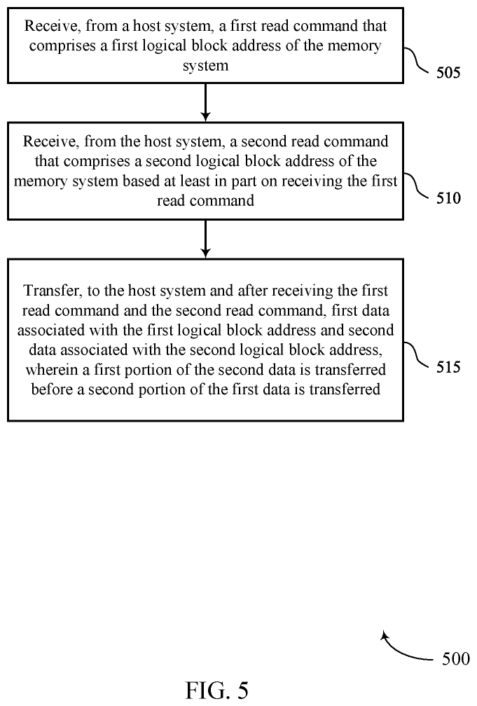

FIG. 5 shows a flowchart illustrating a method 500 that supports memory read performance techniques in accordance with examples as disclosed herein. The operations of method 500 may be implemented by a memory system or its components as described herein. For example, the operations of method 500 may be performed by a memory system as described with reference to FIGS. 1 through 3. In some examples, a memory system may execute a set of instructions to control the functional elements of the device to perform the described functions. Additionally or alternatively, the memory system may perform aspects of the described functions using special-purpose hardware.

At 505, the method may include receiving, from a host system, a first read command that includes a first logical block address of the memory system. The operations of 505 may be performed in accordance with examples as disclosed herein. In some examples, aspects of the operations of 505 may be performed by a command manager 330 as described with reference to FIG. 3.

At 510, the method may include receiving, from the host system, a second read command that includes a second logical block address of the memory system based at least in part on receiving the first read command. The operations of 510 may be performed in accordance with examples as disclosed herein. In some examples, aspects of the operations of 510 may be performed by a command manager 330 as described with reference to FIG. 3.

At 515, the method may include transferring, to the host system and after receiving the first read command and the second read command, first data associated with the first logical block address and second data associated with the second logical block address, where a first portion of the second data is transferred before a second portion of the first data is transferred. The operations of 515 may be performed in accordance with examples as disclosed herein. In some examples, aspects of the operations of 515 may be performed by a data transfer manager 340 as described with reference to FIG. 3.

In some examples, an apparatus as described herein may perform a method or methods, such as the method 500. The apparatus may include, features, circuitry, logic, means, or instructions (e.g., a non-transitory computer-readable medium storing instructions executable by a processor) for receiving, from a host system, a first read command that includes a first logical block address of the memory system, receiving, from the host system, a second read command that includes a second logical block address of the memory system based at least in part on receiving the first read command, and transferring, to the host system and after receiving the first read command and the second read command, first data associated with the first logical block address and second data associated with the second logical block address, where a first portion of the second data is transferred before a second portion of the first data is transferred.

In some examples of the method 500 and the apparatus described herein, allocating, in response to receiving the first read command, a first portion of a read buffer for the first data and allocating, in response to receiving the second read command, a second portion of the read buffer for the second data.

In some examples of the method 500 and the apparatus described herein, the first data and the second data may be transferred to the host system via the read buffer at the memory system.

In some examples of the method 500 and the apparatus described herein, the second read command may be received after the first read command.

In some examples of the method 500 and the apparatus described herein, a first set of pages may be associated with the first logical block address and a second set of pages may be associated with the second logical block address, the first portion of the second data includes a first page of the second set of pages, and the second portion of the first data includes a second page of the first set of pages.

It should be noted that the methods described above describe possible implementations, and that the operations and the steps may be rearranged or otherwise modified and that other implementations are possible. Further, portions from two or more of the methods may be combined.

An apparatus is described. The apparatus may include a non-volatile memory device, a volatile memory device, and a controller coupled with the non-volatile memory device and the volatile memory device, the controller configured to cause the apparatus to receive a first read command that includes a first logical block address of the non-volatile memory device, load, in a page buffer based at least in part on receiving the first read command, first data associated with the first logical block address and second data associated with a second logical block address consecutive with the first logical block address, transfer the first data from the page buffer to a read buffer based at least in part on receiving the first read command and loading the first data in the page buffer, receive, after loading the second data in the page buffer, a second read command that includes the second logical block address, and transfer the second data from the page buffer to the read buffer based at least in part on receiving the second read command and loading the second data in the page buffer.

In some examples, the apparatus may include determine whether a quantity of read commands stored in a command buffer before being performed satisfies a buffer threshold, where loading the second data in the page buffer may be further based at least in part on determining whether the quantity of read commands satisfies the buffer threshold.

In some examples of the apparatus, the controller may be further configured to cause the apparatus to load, in the page buffer, third data from a third logical block address consecutive with the second logical block address based at least in part on receiving the first read command, receive, after loading the third data in the page buffer, a third read command that includes a fourth logical block address different than the third logical block address, load, in the page buffer, fourth data associated with the fourth logical block address based at least in part on receiving the third read command, and transfer the fourth data from the page buffer to the read buffer based at least in part on receiving the third read command and loading the fourth data in the page buffer.

In some examples, the apparatus may include overwrite the third data loaded in the page buffer based at least in part on receiving the third read command.

In some examples, the apparatus may include allocate, in response to receiving the first read command, a first portion of the read buffer for the first data and allocate, in response to receiving the second read command, a second portion of the read buffer for the second data.

In some examples of the apparatus, a first physical address associated with the first logical block address and a second physical address associated with the second logical block address may be consecutive in the non-volatile memory device.

In some examples of the apparatus, the page buffer may be coupled with an array of memory cells of the non-volatile memory device and the read buffer may be included in the volatile memory device.

In some examples of the apparatus, the first data may be transferred from the page buffer to the read buffer via a cache at the apparatus.

Another apparatus is described. The apparatus may include a memory device and a controller coupled with the memory device and configured to cause the apparatus to receive, from a host system, a first read command that includes a first logical block address of the memory device, receive, from the host system, a second read command that includes a second logical block address of the memory device based at least in part on receiving the first read command, and transfer, to the host system and after receiving the first read command and the second read command, first data associated with the first logical block address and second data associated with the second logical block address, where a first portion of the second data is transferred before a second portion of the first data is transferred.

In some examples, the apparatus may include allocate, in response to receiving the first read command, a first portion of a read buffer for the first data and allocate, in response to receiving the second read command, a second portion of the read buffer for the second data.

In some examples of the apparatus, the first data and the second data may be transferred to the host system via the read buffer at the memory device.

In some examples of the apparatus, the second read command may be received after the first read command.

In some examples of the apparatus, a first set of pages may be associated with the first logical block address and a second set of pages may be associated with the second logical block address, the first portion of the second data includes a first page of the second set of pages, and the second portion of the first data includes a second page of the first set of pages.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” refers to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally or alternatively (e.g., in an alternative example) be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorous, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to providing an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over, as one or more instructions or code, a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
a non-volatile memory device;
a volatile memory device; and
a controller coupled with the non-volatile memory device and the volatile memory device, the controller configured to cause the apparatus to:
receive a first read command that comprises a first logical block address of the non-volatile memory device;
load, in a page buffer based at least in part on receiving the first read command, first data associated with the first logical block address and second data associated with a second logical block address consecutive with the first logical block address;
transfer the first data from the page buffer to a read buffer based at least in part on receiving the first read command and loading the first data in the page buffer;
receive, after loading the second data in the page buffer, a second read command that comprises the second logical block address; and
transfer the second data from the page buffer to the read buffer based at least in part on receiving the second read command and loading the second data in the page buffer.

2. The apparatus of claim 1, wherein the controller is further configured to cause the apparatus to:
determine whether a quantity of read commands stored in a command buffer before being performed satisfies a buffer threshold, wherein loading the second data in the page buffer is further based at least in part on determining whether the quantity of read commands satisfies the buffer threshold.

3. The apparatus of claim 1, wherein the controller is further configured to cause the apparatus to:
load, in the page buffer, third data from a third logical block address consecutive with the second logical block address based at least in part on receiving the first read command;
receive, after loading the third data in the page buffer, a third read command that comprises a fourth logical block address different than the third logical block address;
load, in the page buffer, fourth data associated with the fourth logical block address based at least in part on receiving the third read command; and
transfer the fourth data from the page buffer to the read buffer based at least in part on receiving the third read command and loading the fourth data in the page buffer.

4. The apparatus of claim 3, wherein the controller is further configured to cause the apparatus to:
overwrite the third data loaded in the page buffer based at least in part on receiving the third read command.

5. The apparatus of claim 1, wherein the controller is further configured to cause the apparatus to:
allocate, in response to receiving the first read command, a first portion of the read buffer for the first data; and
allocate, in response to receiving the second read command, a second portion of the read buffer for the second data.

6. The apparatus of claim 1, wherein a first physical address associated with the first logical block address and a second physical address associated with the second logical block address are consecutive in the non-volatile memory device.

7. The apparatus of claim 1, wherein:
the page buffer is coupled with an array of memory cells of the non-volatile memory device;
the read buffer is included in the volatile memory device.

8. The apparatus of claim 1, wherein the first data is transferred from the page buffer to the read buffer via a cache at the apparatus.

9. A non-transitory computer-readable medium storing code comprising instructions which, when executed by a processor of an electronic device, cause the electronic device to:
receive a first read command that comprises a first logical block address of the electronic device;
load, in a page buffer based at least in part on receiving the first read command, first data associated with the first logical block address and second data associated with a second logical block address consecutive with the first logical block address;
transfer the first data from the page buffer to a read buffer based at least in part on receiving the first read command and loading the first data in the page buffer;
receive, after loading the second data in the page buffer, a second read command that comprises the second logical block address; and
transfer the second data from the page buffer to the read buffer based at least in part on receiving the second read command and loading the second data in the page buffer.

10. The non-transitory computer-readable medium of claim 9, wherein the instructions, when executed by the processor of the electronic device, further cause the electronic device to determine whether a quantity of read commands stored in a command buffer before being performed satisfies a buffer threshold, wherein loading the second data in the page buffer is further based at least in part on determining whether the quantity of read commands satisfies the buffer threshold.

11. The non-transitory computer-readable medium of claim 9, wherein the instructions, when executed by the processor of the electronic device, further cause the electronic device to:
load, in the page buffer, third data from a third logical block address consecutive with the second logical block address based at least in part on receiving the first read command;
receive, after loading the third data in the page buffer, a third read command that comprises a fourth logical block address different than the third logical block address;
load, in the page buffer, fourth data associated with the fourth logical block address based at least in part on receiving the third read command; and
transfer the fourth data from the page buffer to the read buffer based at least in part on receiving the third read command and loading the fourth data in the page buffer.

12. The non-transitory computer-readable medium of claim 11, wherein the instructions, when executed by the processor of the electronic device, further cause the electronic device to overwrite the third data loaded in the page buffer based at least in part on receiving the third read command.

13. The non-transitory computer-readable medium of claim 9, wherein the instructions, when executed by the processor of the electronic device, further cause the electronic device to:
allocate, in response to receiving the first read command, a first portion of the read buffer for the first data; and
allocate, in response to receiving the second read command, a second portion of the read buffer for the second data.

14. The non-transitory computer-readable medium of claim 9, wherein a first physical address associated with the first logical block address and a second physical address associated with the second logical block address are consecutive in the electronic device.

15. The non-transitory computer-readable medium of claim 9, wherein:
the page buffer is coupled with an array of memory cells of the electronic device;
the read buffer is included in a volatile memory device of the electronic device.

16. The non-transitory computer-readable medium of claim 9, wherein the first data is transferred from the page buffer to the read buffer via a cache at the electronic device.

17. A method performed by a memory system, comprising:
receiving a first read command that comprises a first logical block address of the memory system;
loading, in a page buffer based at least in part on receiving the first read command, first data associated with the first logical block address and second data associated with a second logical block address consecutive with the first logical block address;
transferring the first data from the page buffer to a read buffer based at least in part on receiving the first read command and loading the first data in the page buffer;
receiving, after loading the first data and the second data in the page buffer, a second read command that comprises the second logical block address; and
transferring the second data from the page buffer to the read buffer based at least in part on receiving the second read command and loading the second data in the page buffer.

18. The method of claim 17, further comprising:
determining whether a quantity of read commands stored in a command buffer before being performed satisfies a buffer threshold, wherein loading the second data in the page buffer is further based at least in part on determining whether the quantity of read commands satisfies the buffer threshold.

19. The method of claim 17, further comprising:
loading, in the page buffer, third data from a third logical block address consecutive with the second logical block address based at least in part on receiving the first read command;
receiving, after loading the third data in the page buffer, a third read command that comprises a fourth logical block address different than the third logical block address;
loading, in the page buffer, fourth data associated with the fourth logical block address based at least in part on receiving the third read command; and
transferring the fourth data from the page buffer to the read buffer based at least in part on receiving the third read command and loading the fourth data in the page buffer.

20. The method of claim 19, further comprising:
overwriting the third data loaded in the page buffer based at least in part on receiving the third read command.

21. An apparatus, comprising:
a memory device;
a controller coupled with the memory device and configured to cause the apparatus to:
receive, from a host system, a first read command that comprises a first logical block address of the memory device;
receive, from the host system, a second read command that comprises a second logical block address of the memory device based at least in part on receiving the first read command;
transfer, to the host system and after receiving the first read command and the second read command, first data associated with the first logical block address and second data associated with the second logical block address, wherein a first portion of the second data is transferred before a second portion of the first data is transferred.

22. The apparatus of claim 21, wherein the controller is further configured to cause the apparatus to:
allocate, in response to receiving the first read command, a first portion of a read buffer for the first data; and
allocate, in response to receiving the second read command, a second portion of the read buffer for the second data.

23. The apparatus of claim 22, wherein the first data and the second data are transferred to the host system via the read buffer at the memory device.

24. The apparatus of claim 21, wherein the second read command is received after the first read command.

25. The apparatus of claim 21, wherein:
a first set of pages are associated with the first logical block address and a second set of pages are associated with the second logical block address;
the first portion of the second data comprises a first page of the second set of pages;
the second portion of the first data comprises a second page of the first set of pages.
